(19) United States
(12) Patent Application Publication
(10) Pub. No.: US 2011/0140625 A1
(43) Pub. Date: Jun. 16, 2011

(54) METHOD AND SYSTEM FOR OPERATING A HIGH INTENSITY DISCHARGE LAMP

(75) Inventor: Dolf H.J. Van Casteren, Eindhoven (NL)

(73) Assignee: KONINKLIJKE PHILIPS ELECTRONICS N.V., EINDHOVEN (NL)

(21) Appl. No.: 13/059,430

(22) PCT Filed: Aug. 17, 2009
(86) PCT No.: PCT/IB09/53622

§ 371 Date: Feb. 17, 2011

(30) Foreign Application Priority Data
Aug. 22, 2008 (EP) 08162792.9

(51) Int. Cl. H05B 41/16

(52) U.S. Cl. 315/246

(57) ABSTRACT

The present invention provides a lighting system 10 for operating a high intensity discharge (HID) lamp 12, comprising: a converter 200 for converting an input voltage to a DC current; a commutator 202 coupled to the converter for converting the DC current to an alternating drive current; a voltage controlled feedback loop 204 for adjusting said DC current, which is connected between an output and an input of the converter; a processor 206 for controlling the feedback loop, wherein the processor is adapted to adjust a damping level of the feedback loop by controlling a gain level of the feedback loop depending on a measured lamp current. The feedback loop has one or more adjustable gain levels. The processor adjusts the one or more gain levels to limit overshoot or undershoot of the lamp current following drive current transitions. The processor can adjust the gain levels of the VCL using the rising and/or falling transitions of the lamp current.

### FIELD OF THE INVENTION

The present invention relates to a method and system for operating a high intensity discharge lamp.

### BACKGROUND OF THE INVENTION

A High-intensity discharge (HID) lamp is a type of electrical lamp which produces light by means of an electric arc between electrodes housed inside a translucent or transparent tube, made of for instance fused quartz or fused alumina. The tube is filled with both gas and metal salts. The gas facilitates the arc's initial strike. Once the arc is started, it heats and evaporates the metal salts forming a plasma, which greatly increases the intensity of light produced by the arc and reduces its power consumption. High-intensity discharge lamps are a type of arc lamp. The light-producing element of the HID lamp types is a well-stabilized arc discharge contained within a refractory envelope (arc tube).

Compared with fluorescent and incandescent lamps, HID lamps have higher luminous efficacy since a greater proportion of their radiation is in visible light as opposed to heat. Their overall luminous efficacy is also much higher, i.e. they give a greater amount of light output per watt of electricity input.

Various different types of chemistry are used in the arc tubes of HID lamps, depending on the desired characteristics of light intensity, correlated color temperature, color rendering index (CRI), energy efficiency, and lifespan. Varieties of HID lamp include for instance mercury vapor lamps, metal halide (MH) lamps, ceramic MH lamps, high-pressure and low-pressure sodium vapor lamps, and xenon short-arc lamps.

For instance quartz and ceramic metal halide lamps can be made to give off substantially neutral white light. Neutral white light is useful for applications where normal color appearance is critical, such as TV and movie production, movie projectors and beamers, indoor or nighttime sports games, automotive headlamps, and aquarium lighting.

When used in projection systems, discharge lamps are preferably driven with alternating currents. Current pulses can be used to stabilize the arc attachment. These pulses serve to effectively prevent arc jumping. However, the current pulses lead to an uneven light emission over time and may produce color artifacts in projection systems with time sequential color display.

This problem is further complicated by the lifetime behavior of a discharge lamp. Generally, the electrical properties of the lamp change during its lifetime. Usually the lamp voltage increases due to electrode burn-back. In order to keep the electrical operating power constant, the lamp current needs to be reduced accordingly.

HID lamps have negative incremental impedance and therefore must be operated in series with a current controlled ballast. However, power electronics-based HID or UHP ballasts do not act as ideal current sources. Accordingly, the resulting system performance depends on the dynamics of the lamp as well as the ballast, the so-called lamp-ballast interaction. Some combinations tend to be poorly damped, resulting in oscillatory lamp current. To operate a broad range of HID or UHP lamps, an active controlled lamp-ballast interaction is desirable. This control is also necessary to achieve stable lamp operation at normal or reduced power operation when a small current overshoot and over critical-damping is desired.

To get a grip on the under damped mode of the system, the prior art discloses an adaptive Voltage Control feedback Loop (VCL). The VCL principle for driving HID or UHP lamps is for instance described in Philips patent application WO-2006/056918-A1.

The damping level of the Voltage Control Loop (VCL) is preferably as low as possible to avoid side effects like feedback or cathode fall voltage steps. On the other hand, too little damping can lead to instable lamp current behavior. The current overshoot during a standard current transition (for example the drive current commutation) is used for the average setting of the damping level. By increasing the damping level the overshoot diminishes. However, the aim for zero current overshoot or even undershoot can lead to too high damping levels and instable lamp-ballast behavior. In order to stabilize difficult wave shape transitions additional measures must be taken. To avoid picture artifacts the light, and hence the lamp current, must obey predetermined current settings very accurately.

Up to now, this has been realized by means of empirical control tables or Iterative Learning Control (ILC), such that satisfactory lamp performance was achieved during the lifetime of the lamp. The ILC algorithm for UHP application is disclosed in Philips patent application WO-2006/046199-A1. Many UHP devices on the market are based on the robust ILC approach. However, due to price erosion, there is a need for a more cost effective solution.

### OBJECT OF THE INVENTION

In view of the above, the present invention aims to provide a more cost efficient solution for setting the lamp current.

### SUMMARY OF THE INVENTION

The present invention therefore provides a lighting system for operating a high intensity discharge (HID) lamp, comprising:

a converter for converting an input voltage to a predetermined DC current;

a commutator coupled to the converter for converting the DC current to an alternating drive current for driving the lamp;

voltage controlled feedback loop, which is connected between an output and an input of the converter, for adjusting the DC current;

a processor for controlling the feedback loop, wherein the processor is adapted to adjust a damping level of the feedback loop depending on a measured lamp current (Ilamp).

The lighting system of the invention can measure the lamp current. The measured lamp current is compared with the preset drive current to determine differences. The damping level of the feedback loop is subsequently (temporarily) adjusted. The system of the invention is highly flexible, relatively simple and cheap. The system can compensate for changing lamp-ballast interaction, thus obviating the need for early replacement and increasing the economic lifetime of the lamp.

In an embodiment, the feedback loop has a first damping level and at least one adjustable second damping level. The second damping level can be used to compensate for lamp current deviations after a drive current transition, such as a commutation or a current pulse. The second damping level can be active during a predetermined time period. The time period can be adapted to the setting time of the lamp current after a drive current transition, and may be relatively short. In addition, the first damping level can keep the average damping level within a predetermined range. Also, the first (lower) damping level prevents unstable lamp-ballast behavior when the second damping level increases.

In another embodiment, the processor is adapted to:

measure the lamp current;

use the lamp current to calculate a high reference value;

calculate a low reference value using the lamp current and the drive current; and

increase the damping level if the measured lamp current after a falling edge transition is lower than the low reference value; or

decrease the damping level if the measured lamp current after the falling edge transition is higher than the low reference value.

In another embodiment, the processor is adapted to:

measure the lamp current;

use the lamp current to calculate a high reference value; and

increase the damping level if the measured lamp current after a rising edge transition is higher than the high reference value; or

decrease the damping level if the measured lamp current after the rising edge transition is lower than the high reference value.

Optionally, the processor is adapted to obtain a number of samples of the lamp current after a transition of the drive current during a time interval.

The feedback loop may include a first resistor; and a series of a second resistor and a diode connected in parallel to the first resistor.

Additional features and advantages will be apparent from the enclosed drawings and the corresponding description below.

### BRIEF DESCRIPTION OF THE DRAWINGS

FIG. 1 shows an exemplary diagram of a projection system;

FIG. 2 shows a graph of a current pulse sequence for driving the lamp of the projection system of FIG. 1;

FIG. 3 shows a diagram of an embodiment of a lighting system according to the present invention;

FIG. 4 shows a diagram of another embodiment of a lighting system according to the present invention;

FIG. 5 shows exemplary graphs of the set drive current Iset and the VCL damping level according to a practical example of the lighting system of the present invention;

FIGS. 6-9 show exemplary graphs of the set drive current Iset, the lamp current Ilamp, and the VCL damping level; and

FIG. 10 shows a diagram of a detailed practical example of the embodiment of FIG. 4.

### DETAILED DESCRIPTION OF EXAMPLES

A kind of HID lamp, an Ultra High Pressure (UHP) lamp, is a Philips invention that has become the preferred light source for projection systems. The pressure inside the tube of an UHP lamp is for instance greater than about 200 atm.

A drawback of the UHP lamp is the instability of the electrode attachment on the surface of the electrodes. This instable behavior could result in visible effects in the picture, such as flicker. The application of UHP lamps in a projection system sets new and more stringent requirements on the quality of the light generated by these lamps. Variations in the lamp current translate to variations of the light output of the lamp, which may lead to unwanted color effects in the projected image. Reference is made to WO-00/36883 for a more detailed description of a pulse operated UHP lamp system.

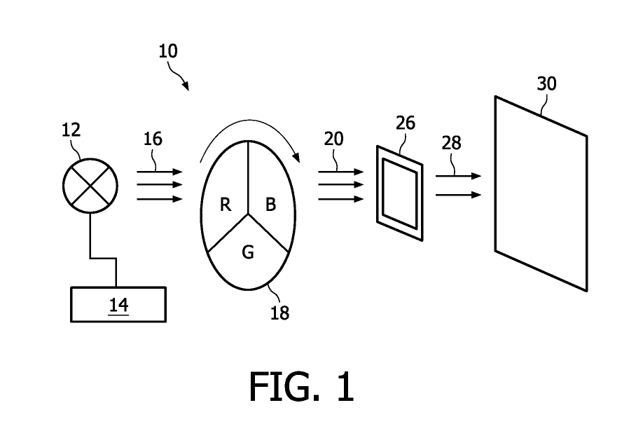

An exemplary projection system 10 (FIG. 1) includes a lamp 12 driven by electronic ballast 14. The projection system 10 can include a color filter to generate a sequence of color time periods, each having a different constant color light output. When driven by the ballast, the lamp emits light 16 in the direction of the color filter. The color filter is for instance a rotatable color wheel 18 having colored segments. The wheel for instance has three segments R, G, B, wherein R=red, G=green and B=blue. The wheel 18 can also comprise two, or more than three color segments. The spectral distribution of the light 16 depends on the lamp and the lamp current, but will comprise substantially all colors. As the color wheel 18 rotates, a color modulated light sequence 20 is generated. The sequence 20 is directed towards projection screen 30. Optionally, shutter 26 is arranged in between the screen 30 and the lamp 12 to reduce the light output level when required. When the color filter 18 switches from one color segment to another segment, the light is temporarily blocked by the filter. This (relatively short) time period in between subsequent color time periods is called a spoke time period.

The projection system described above is a time-sequential system. Time-sequential means that the lamp 12 produces different colors at different moments in time using a rotating color wheel 18 in the light path (FIG. 1). The color wheel segmentation depends on the trade-off between color rendering, brightness and gray scale quality. For each different color wheel, a matching lamp current pulse sequence is designed. For a detailed description of the projection system, reference is for instance made to WO-2006/056926-A1.

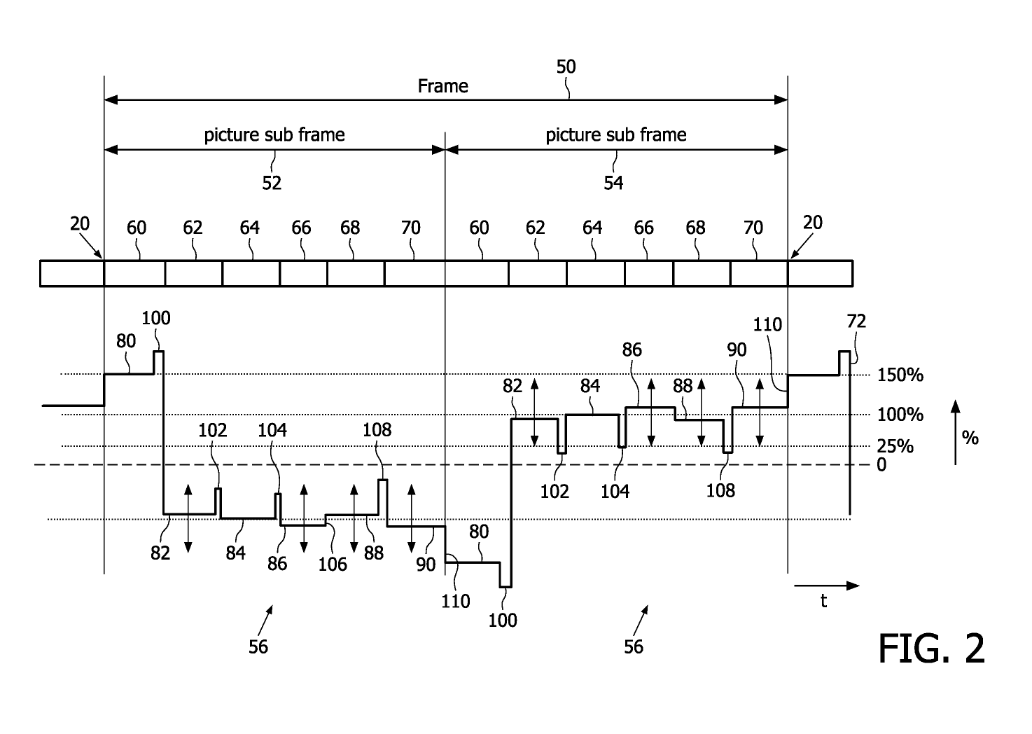

A picture frame 50 (FIG. 2) comprises for instance two picture sub-frames 52, 54. Each picture sub-frame comprises one light sequence 20, including consecutive color time periods. The color time periods 60, 62, 64, 66, 68, 70 correspond for instance to the colors blue, turquoise, red, magenta, green and yellow respectively.

FIG. 2 also shows drive current 72. The x-axis represents the time t, and the y-axis represents the drive current value as a percentage of a predetermined optimal or basic drive current, which is indicated as 100%. The basic drive current is a square wave alternating current. Each picture sub-frame 52, 54 corresponds to the duration of a half period of the basic drive current.

During each color period, the drive current 72 may be substantially constant or ends with a dark pulse (102, 104, 108) to improve the gray scale resolution. The sequence of color time periods thus includes a sequence 56 of first current pulses 80, 82, 84, 86, 88, 90. The sequence repeats periodically. The sequence 56 also comprises dark pulse periods 102, 104, 108 ending in the spoke time in between the respective color time periods. During the dark pulse periods, the drive current 72 is temporarily decreased, for instance to about 25% to 50% of the basic drive current. The spoke time periods incorporate the transition from one constant color time period to another.

The current plateau 80 is called brilliant pulse. During the brilliant pulse 80, the drive current is temporarily increased with respect to the basic drive current, for instance to about 125% to 150% thereof. The brilliant pulse 80 plays a role in the adjustment of the color balance of the projection system.

The sequence 56 may optionally include an anti flatter pulse 100 just before changing the polarity of the drive current 72, and thus the lamp current (in case of an alternating current). The anti flatter pulse 100 can be introduced to stabilize the arc attachment, for instance of ageing lamps.

Additionally, during dark scenes, the shutter 26 may reduce the light level on the screen 30 (FIG. 1).

Dark pulse periods 102, 104, 108 are preferably shorter than the first current pulses 80-90. The light generated during spoke time periods cannot be used to generate a color image. During spoke time periods, the light output may be either blocked completely or be used to brighten the total projected image, without regard to color.

The ballast 14 generates the square wave basic drive current, as well as the current pulses to stabilize the arc of the lamp 12. The current pulses are added to the basic drive current to provide the drive current 72. The basic drive current has a period corresponding to the duration one picture frame 50.

The amplitude of the basic drive current is indicated as 100% in FIG. 2. The ballast 14 generates first current pulses to increase or decrease the drive current 72 during the color time periods, as indicated by arrows in pulses 82, 85, 88 and 90 in FIG. 2. The first current pulses are superimposed on the basic drive current during one or more of the color time periods. A first current pulse may be active during the complete duration of the color time period or only during a fraction of the color time period. The first current pulses effectively increase or decrease the drive current with respect to the basic drive current during the respective color time period.

The technology using first current pulses may boost certain colors of the color sequence 20. Using the first pulses to increase or decrease certain colors has a considerable effect on brightness and color temperature, enabling high brightness (boosting white) or lower color temperature (boosting red).

Amplitude modulation of the drive current 72, and consequently the lamp current by means of the dark pulses (102, 104, 108), during the color time periods, enables for instance up to 2 extra bits to be created in the gray scale and/or results in an impressive reduction of dither noise. Using two types of current pulses (first current pulses and dark pulse periods) during the same half period of the alternating drive current 72 allows a flexible approach to arc stabilization.

To avoid picture artifacts, the light 16, and therefore the lamp current also, must accurately obey the above described settings. The ballast 14 drives the lamp 12, and thus the ballast must accurately control the drive current and the resulting lamp current.

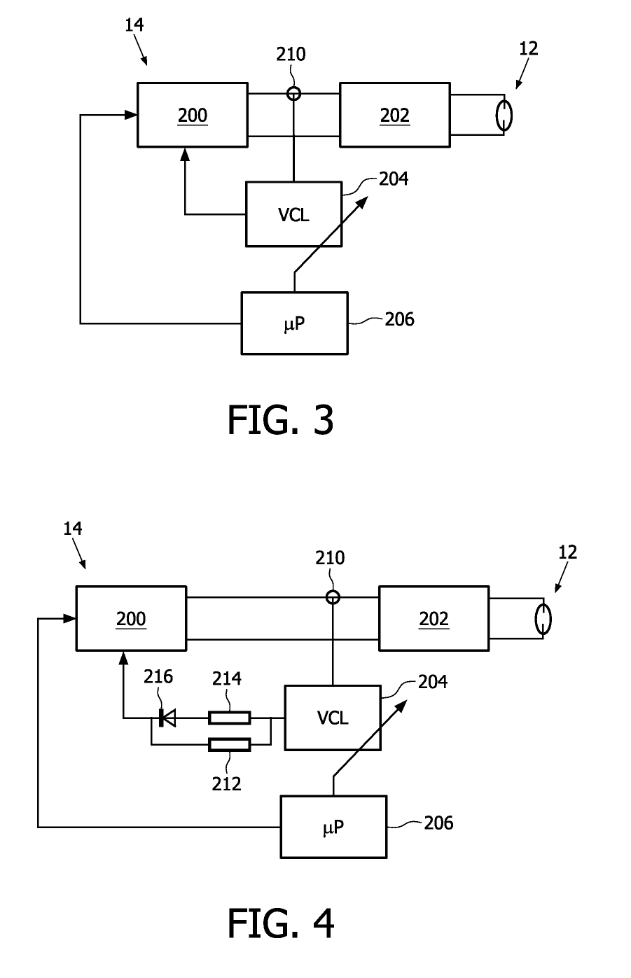

As shown in FIG. 3, the ballast for instance includes a converter 200, a commutator 202, a Voltage Controlled Loop (VCL) 204, and a microprocessor 206.

The converter 200 can be connected to an electrical power source, such as mains. The converter 200 is for instance a buck converter for converting the alternating mains voltage to a DC voltage, and/or for converting the DC voltage to another, for instance higher DC voltage.

The commutator 202 is connected to the output of the converter 200, and is adapted to convert the input voltage into a square wave current. The square wave current is supplied to the lamp 12. The commutator comprises for instance a half bridge or full bridge circuit including two or four electronic switches respectively. In other embodiments, the commutator may include a Pulse Width Modulated (PWM) or class D switching amplifier arrangement. The commutator may include any number of electronic switches to supply a predetermined output current.

The VCL 204 is connected to node 210, between the converter 200 and the commutator 202. On its other end, the VCL is connected to the converter 200 and thus forms a feedback loop. The VCL is adapted to measure the voltage at node 210.

The microprocessor 206 is connected to the VCL, to the converter and to the commutator for controlling thereof The microprocessor 206 is adapted to control the output of the converter 200 which output substantially corresponds to the set drive current for the lamp 12. The microcontroller is also coupled to the commutator 202 to obtain or measure the actual lamp current through the lamp 12.

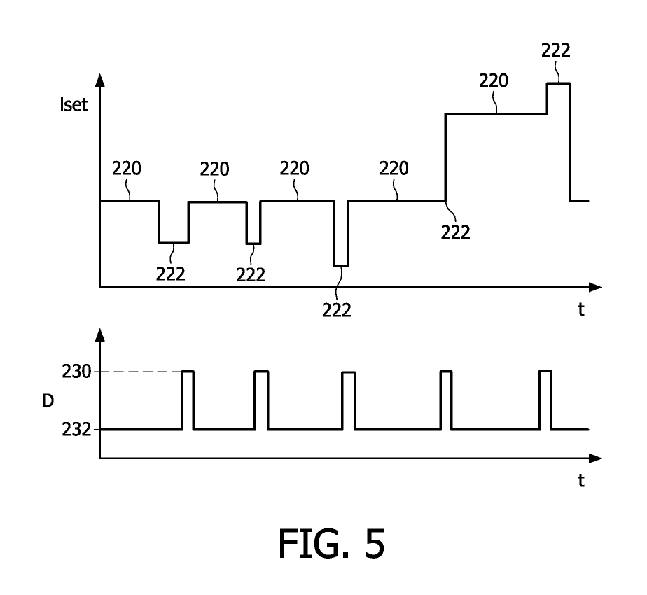

Optionally (FIG. 4), the feedback path of the ballast 14 also includes first resistor 212, second resistor 214 and diode 216. The first resistor is connected in parallel to the series of second resistor 214 and the diode 216. The feedback path is the connection between the VCL 204 and the converter 200.

The damping level of the voltage control loop (VCL) is preferably as low as possible to avoid side effects like feedback of cathode fall voltage steps. In addition, too high damping can lead to instable lamp current behavior. The current overshoot during a standard current transition (for example the square wave drive current commutation) is used for the average gain setting. By increasing the damping level the overshoot diminishes. However, the aim for zero overshoot or even undershoot can lead to too high damping and instable system behavior. It is preferred to take measures to further stabilize difficult drive current wave shape transitions.

The damping level of the VCL is related to the VCL gain level. Depending on the practical implementation, the damping level may be directly proportional, or inversely proportional to the VCL gain level.

The VCL damping level can be controlled by means of software of hardware of the microprocessor 206. In this procedure a drive current transition is identified and in an iterative process optimized for fast settling and low overshoot. Tests have shown that optimizing the falling edge of the drive current results in an under-damped rising edge. A modified damping level can optimize the rising edge of the drive current, loosing the fast settling time for the falling edge. It has been found that rising edge current transitions require a different VCL damping level then falling edge current transitions, due to a non-linear lamp-ballast interaction behavior.

The lighting system of the present invention applies a wave-shape dependent VCL damping level to optimize a superimposed sequence of pulses on the (low frequency square wave) lamp current.

The present invention includes the following exemplary embodiments:

1. Adjustable VCL damping level synchronized with the wave shape of the lamp current (FIG. 3); and

2. Adjustable VCL damping level including asymmetrical circuitry (FIG. 4).

The VCL damping level can be (temporarily) adjusted to provide an appropriate damping level for or during the positive and negative transitions of the lamp current on an iterative basis. The microprocessor 206 is adapted to adjust the VCL damping level. The microprocessor includes appropriate hardware and/or a software algorithm.

The microprocessor defines the VCL damping level for positive and/or negative edges in the lamp current. Additional hardware may add a fixed amount to the damping level that corresponds to positive and/or negative rising edges of the lamp current.

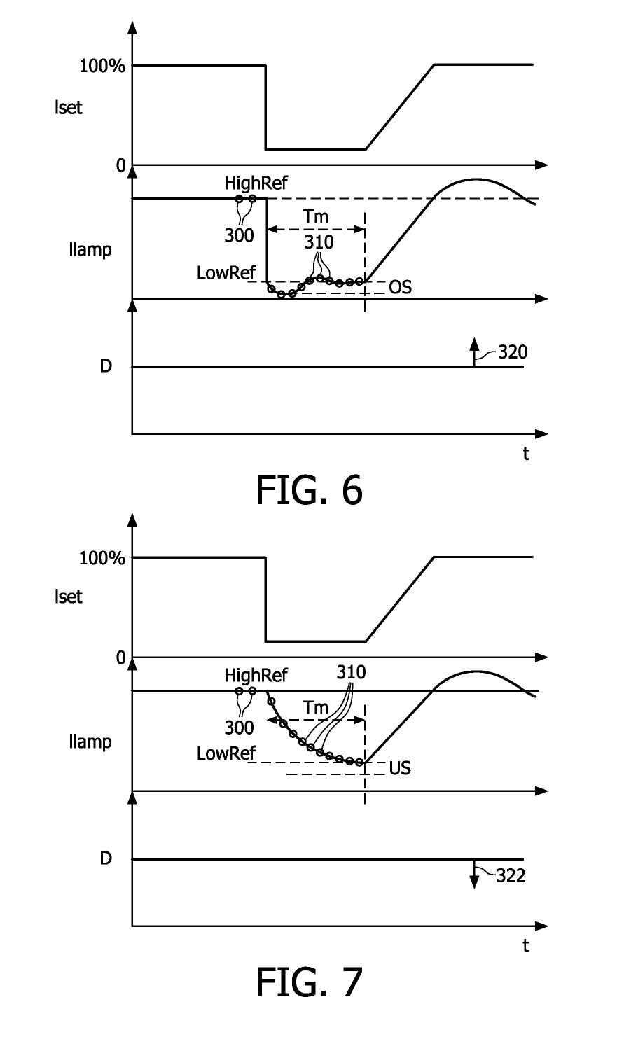

FIG. 5 shows exemplary plots wherein the y-axis represent the drive current Iset that is supplied to the lamp and the corresponding VCL damping level D. The x-axis represents the time t. The drive current can be compared to the current 72 shown in FIG. 2, having first current pulse periods 220 and second (dark or bright) current pulse periods 222. During the second current pulse periods 222 and including the rising edge of the drive current, the damping level D is temporarily increased.

In the example of FIG. 5, the damping level D has two different levels 230, 232. The damping level is set at a relatively low basic damping level 232. Before the drive current Iset switches to a higher amplitude (a rising edge), the damping level increases to the second damping level 230. The second damping level can be adjusted depending on overshoot or undershoot of the measured lamp current after a drive current transition, as explained below. The damping level D is increased to the second damping level 230 during a time interval. The microprocessor can adjust the time interval. The time interval can for instance be adjusted depending on the step of the drive current, the amplitude of the drive current before or after the transition, the fall or rise time of the drive current, etc.

Switching of the drive current to a higher level or amplitude is indicated as a positive or rising edge. Switching of the drive current to a lower level is indicated as a negative of falling edge.

The lamp current wave-shape performance in terms of settling time and overshoot can be improved further by introducing more than two VCL damping levels for respective transitions of the drive current. The transitions may include rising and/or falling edges of the lamp current.

To adjust the VCL damping level, the microprocessor performs the following steps:

1. Measure lamp current overshoot after a drive current transition during an appropriate time interval;

2. Define the maximum value for the observed samples of the lamp current;

3. Increase or decrease the VCL damping level with a predetermined step;

4. Measure the lamp current response again;

5. If the overshoot of the lamp current after a drive current transition is reduced, increase the damping level again with a predetermined step. Else, stop or reduce the damping level.

6. In case of undershoot of the lamp current after a drive current transition, decrease the VCL damping level with a predetermined step.

The predetermined step can be the smallest step possible. For instance, the microprocessor may determine the predetermined step as a Least Significant Bit of a register.

The preferred current transition is the falling edge transition providing the greatest change of the drive current.

For wave shapes of the drive current without falling edges, the drive current transition having the highest rising edge is preferred.

The algorithm is for instance executed during a predetermined time interval, i.e. the algorithm ends at the end of the time interval.

The algorithm is for instance executed after power-up or when the power level is changed. Also, the algorithm can be repeated at a predetermined time interval, for instance every 5 or 10 minutes, or every 2 hours.

### Example using Falling Edge

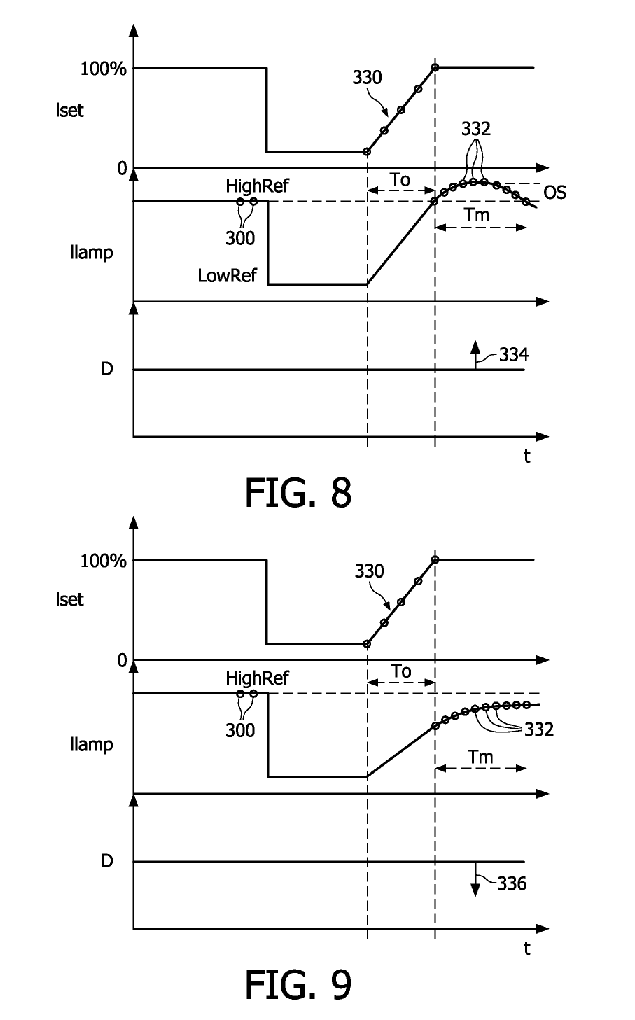

FIGS. 6-9 each show three graphs, having a corresponding x-axis that represents the time t. The vertical y-axis of the upper graph represents the set drive current Iset. The y-axis of the graph in the middle represents the lamp current Ilamp. The y-axis of the lower graph represents the damping level D, i.e. the (adjustable) damping level of the VCL.

FIGS. 6-9 clarify examples of the use of the lighting system according to the present invention. FIGS. 6 and 7 concern adjustment of the VCL damping level depending on a falling edge of the lamp current. FIGS. 8 and 9 concern adjustment of the VCL damping level depending on a rising edge of the lamp current.

At first, the damping level D is set at a predetermined basic damping level. The basic damping level is comparable to level 230 in FIG. 5, and is depicted in the lower graph of FIGS. 6-9.

Secondly, the ballast 14 obtains a number of lamp current samples 300. The average value of the samples 300 constitutes a High Reference Value (HighRef). The high reference value is for instance the mean value of two samples 300.

A number of second samples 310 is obtained when the amplitude of the measured lamp current Ilamp drops below the High Reference Value. The second samples are obtained during a measurement time Tm. FIGS. 6 and 7 depict 10 samples 310. However, any number of samples 310 that is sufficient for achieve a predetermined accuracy is conceivable.

A Low Reference Value (LowRef) is calculated by multiplying the High Reference Value with the value of the dip of the set drive current Iset. For instance:

HighRef=100H;

Dip value=25%;

LowRef=100H×25%=25H,

wherein 100H is an exemplary value, representing a value of 100 times the smallest possible step of a register of the microprocessor.

In a subsequent step, the current overshoot (OS in FIG. 6) or undershoot (US in FIG. 7) after a falling edge transition in the time interval Tm is calculated.

Define the minimum value of the samples by taking the lowest value.

Determine the overshoot (OS) or undershoot (US) by subtracting this minimum value from the Low Reference (LowRef) value.

Overshoot (OS) means that the smallest sample 310 is smaller than the Low Reference Value (FIG. 6), indicating that the system is under-damped. The damping level is subsequently increased with a small step, for instance 1 Least Significant Bit (LSB) of a register of the microprocessor 206. Increasing the damping level of the feedback path is indicated by arrow 320.

After increasing the damping level, the above described steps are repeated. If the overshoot is reduced, the damping level is increased one more step, for instance 1 LSB. If the overshoot is increased, the damping level is decreased with a small step (1 LSB). To prevent the system from oscillating between two values of the VCL damping level, the method is ended after switching back and forth between the same two values a number of times, for instance, about five times.

Undershoot (US) means that the smallest sample 310 is larger than the Low Reference Value (FIG. 7), indicating that the system is over-damped. The system decreases the damping level with a small step (1 LSB). Decreasing the damping level of the feedback path is indicated by arrow 322.

After decreasing the damping level, the above steps are repeated. If the amount of undershoot is reduced, the system decreases the damping level in a subsequent step. Otherwise the damping level is increased with a small step (1 LSB).

Optionally, a mean value of the overshoot or undershoot is calculated. The mean value of the overshoot or undershoot is used to adjust the VCL damping level. Using the mean value of, for instance three to five, measurements increases the accuracy and prevents instability.

### Example using Rising Edge

Instead of, or in addition to the above described method, a method for adjusting the VCL damping level related to a rising edge of the lamp current can be used (FIGS. 8, 9).

At first, the VCL damping level is set at a predetermined basic damping level. The basic damping level is comparable to level 230 in FIG. 5, and is depicted in the lower graph of FIGS. 8, 9.

Secondly, the ballast 14 obtains a number of samples 300. The average value of the samples 300 constitutes a High Reference Value (HighRef). The high reference value is for instance the mean value of two samples 300.

In the examples of FIGS. 8 and 9, the rising edge 330 of the set drive current has a constant slope, i.e. di/dt=constant. The set drive current rises during time To from the lower value (for instance 25% of the basic drive current) to the higher value (for instance 100%).

When the set drive current has reached the highest value, the system obtains a number of samples 332 during a measurement time Tm. FIGS. 8, 9 depict ten samples 332. However, any number of samples 332 that is sufficient for achieve a predetermined accuracy is conceivable.

In a subsequent step, the maximum value of the samples 332 is derived by taking the highest value thereof.

The High Reference Value (HighRef) is subtracted from said maximum value of the samples 332 to determine the overshoot (OS, FIG. 8) or undershoot (US, FIG. 9).

Overshoot (OS) means that the maximum value of samples 332 is higher than the High Reference Value (FIG. 8), indicating that the system is under-damped. The damping level is subsequently increased with a small step, for instance 1 Least Significant Bit (LSB) of a register of the microprocessor 206. Increasing the damping level of the feedback path is indicated by arrow 334.

After increasing the overall gain, the above described steps are repeated. If the overshoot is reduced, the damping level is increased one more step, for instance 1 LSB. If the overshoot is increased, the damping level is decreased with a small step (1 LSB). To prevent the system from oscillating between two values of the VCL damping level, the method is ended after switching back and forth between the same two values, for instance, about five times.

Undershoot (US) means that the sample 332 having the maximum value is smaller than the High Reference Value (FIG. 9), indicating that the system is over-damped. The system decreases the damping level with a small step (1 LSB). Decreasing the damping level of the feedback path is indicated by arrow 336.

After decreasing the damping level, the above steps are repeated. If the amount of undershoot is reduced, the system decreases the damping level D in a subsequent step. Otherwise the damping level is increased with a small step (1 LSB).

Optionally, a mean value of the overshoot or undershoot is calculated. The mean value of the overshoot or undershoot is used to adjust the VCL gain. Using the mean value of, for instance three or four, measurements increases the accuracy and prevents instability.

The microprocessor defines the VCL damping level for positive and/or negative edges in the lamp current. Additional hardware may add a fixed amount to the damping level corresponding to the positive and/or negative rising edges of the lamp current (FIG. 4).

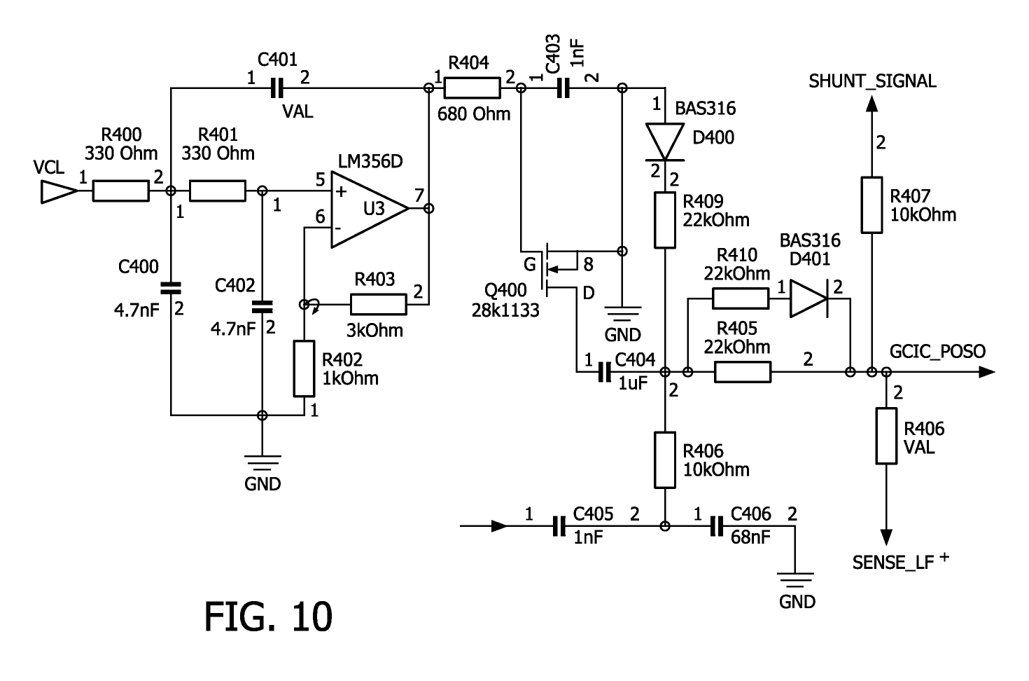

FIG. 10 shows a detailed circuit diagram of a practical embodiment of the system of FIG. 4. Resistors, op-amps, diodes, capacitors and other electrical components are depicted using their regular symbols. Values are indicated as example only. The embodiment of FIG. 10 includes a VCL input on the left, which via resistor R400 is supplied to operational amplifier U3. The output of amplifier U3 is supplied to the gate of MOSFET Q400.

In the embodiment of FIG. 10, the VCL gain setting can be adjusted by adjusting the gain level of amplifier U3. The damping level of the feedback loop of FIG. 10 is inversely proportional to the gain level.

In a practical embodiment, the picture frame 50 (FIG. 2) is repeated at a frequency of about 50 to 60 Hz. The corresponding basic drive current thus has a frequency of about 50 to 60 Hz. It is also possible to use higher repetition rates, claiming improved picture quality. The picture frame may for instance be repeated at a frequency of about 100 to 120 Hz. The basic drive current will have a corresponding frequency of about 100 to 120 Hz.

The microprocessor may obtain samples of the lamp current (FIG. 6) at a sample rate of about 10 to 100 kHz, for instance 50 kHz. A sample can last about 1 to 100 μs, for instance about 20 μs. The number of samples pas rising and/or falling edge of the lamp current can be in the range of 5 to 50 samples, for instance about 10 samples per current transition. The measurement time Tm is for instance in the range of 5 to about 500 μs.

The present invention is not limited to the above-described embodiments. Features of different embodiments may for instance be combined. Many other modifications are conceivable within the scope of the appended claims.

1. Lighting system (14) for operating a high intensity discharge (HID) lamp, comprising:
a converter (200) for converting an input voltage to a DC current;
a commutator (202) coupled to the converter for converting the DC current to an alternating drive current for driving the lamp;
a voltage controlled feedback loop (VCL, 204), which is connected between an output and an input of the converter (200), for adjusting said DC current;
a processor (206) for controlling the feedback loop, wherein the processor is adapted to adjust a damping level (D) of the feedback loop (204) depending on a measured lamp current (Ilamp).

2. The system of claim 1, wherein the feedback loop (204) has a first damping level (232), and at least one adjustable second damping level (230).

3. The system of claim 2, wherein the first damping level (232) is lower than the second damping level (230).

4. The system of claim 2, wherein the feedback loop has the second damping level (230) during an adjustable time interval.

5. The system of claim 4, wherein the adjustable time interval is relatively short compared to a time interval during which the feedback loop has the first damping level (232).

6. The system of claim 1, wherein the processor (206) is adapted to:
measure the lamp current (Ilamp);
use the lamp current to calculate a high reference value (HighRef);
calculate a low reference value (LowRef) using the lamp current and the drive current; and
increase the damping level (D) if the measured lamp current after a falling edge transition is lower than the low reference value; and/or
decrease the damping level (D) if the measured lamp current after the falling edge transition is higher than the low reference value.

7. The system of claim 1, wherein the processor (206) is adapted to:
measure the lamp current (Ilamp);
use the lamp current to calculate a high reference value (HighRef); and
increase the damping level (D) if the measured lamp current after a rising edge transition (330) is higher than the high reference value; and/or
decrease the damping level (D) if the measured lamp current after the rising edge transition is lower than the high reference value.

8. The system of claim 1, wherein the processor (206) is adapted to obtain a number of samples (310, 332) of the lamp current (Ilamp) after a transition of the drive current (Iset) during a time interval (Tm).

9. The system of claim 1, wherein the feedback loop (204) includes:
a first resistor (212); and
a series of a second resistor (214) and a diode (216), connected in parallel to the first resistor (212).
